(19) United States
(12) Patent Application Publication
(10) Pub. No.: US 2016/0252167 A1
(43) Pub. Date: Sep. 1, 2016

(54) TENSIONING RAIL WITH BAYONET CATCH

(71) Applicant: iwis motorsysteme GmbH & Co. KG, Munchen (DE)

(72) Inventors: Yannick GUYOT, Wolfratshausen (DE); Phillipp VON VOPELIUS-FELDT, Kiefersfelden (DE)

(21) Appl. No.: 15/046,263

(22) Filed: Feb. 17, 2016

(30) Foreign Application Priority Data
Feb. 27, 2015 (DE) 102015002567.8

(51) Int. Cl. F16H 7/08

(52) U.S. Cl. CPC F16H 7/08; F16H 2007/0872; F16H 2007/0893

(57) ABSTRACT

A tensioning rail unit for an endless drive, comprises a tensioning rail arranged for pivoting about a pivotable arrangement and a tensioner acting on the tensioning rail and including a housing and a tensioning piston guided in the housing, wherein the housing has an arm having attached thereto a first element of the pivotable arrangement, the tensioning rail has attached thereto a second element of the pivotable arrangement, and the first and second elements are adapted to be mounted at a mounting position by means of a plug-in movement and to be transferred to a locked operating position by means of a subsequent pivoting movement. The first or the second element is configured as an accommodation pocket open in the direction of the pivot axis, the accommodation pocket being provided with a pocket opening having a lateral opening which is open over an angular range of less than 180°, and the respective other element is configured as a pivot pin held by a fastening section dimensioned at the mounting position, that can be attached in the direction of the pivot axis due to the lateral opening of the accommodation pocket and engages then, by the subsequent pivoting movement, a locking slot intersecting the pocket opening, the locking slot being formed in the accommodation pocket.

### CROSS-REFERENCE TO RELATED APPLICATION

This application claims priority to foreign German patent application No. 102015002567.8, filed on Feb. 27, 2015, the disclosure of which is incorporated by reference in its entirety.

### FIELD OF THE INVENTION

The present invention relates to a tensioning rail unit for an endless drive, comprising a tensioning rail arranged for pivoting about a pivotable arrangement and a tensioner acting on the tensioning rail and including a housing and a tensioning piston guided in said housing, wherein the housing has an arm having attached thereto a first element of the pivotable arrangement, the tensioning rail has attached thereto a second element of the pivotable arrangement, and the first and second elements are adapted to be mounted at a mounting position by means of a plug-in movement and to be transferred to a locked operating position by means of a subsequent pivoting movement.

### BACKGROUND

Such tensioning rail units are used especially for chain drives at internal combustion engines. Preferably in the case of smaller chain drives, tensioning mechanisms consisting of a unit comprising a tensioning rail and a tensioner are used in the slack span. Such embodiments are in some cases also referred to as hinge-type tensioners. The special characteristic of these tensioning rail units is mainly that the tensioning rail is pivotably attached to the housing of the tensioner. The tensioner housing often consists of cast metal and the tensioning rail is often made of a plastic material. For creating the pivotable arrangement, the prior art offers various possibilities of construction. One possibility is that a pin is press-fitted into a housing projection, said pin extending then through two pivot eyes of the tensioning rail. Another possibility is the use of a clip connection. In such a clip connection, one arm of the housing has attached thereto a pivot pin, which projects on both sides and which has then clipped thereonto a fork head of the tensioning rail, said fork head being provided with a detent connection. The detent connection must, however, be capable of taking up the preload force of the tensioning piston at the transport position, without the tensioning rail being released. A third known possibility is the use of a laterally open fork head, which, at a specific mounting position, can be pushed onto a pin projecting beyond the housing on both sides thereof. The tensioning rail is pivoted together with the fork head and the outer surface of the fork head enters into contact with a suitably adapted housing contour such that it is no longer possible to release the tensioning rail at the operating position. The amount of material required for the housing according to this solution is, however, comparatively large. In addition, the necessary mounting steps are very difficult to automate, since the guiding effect is primarily accomplished by means of the housing and not by means of the pin.

### SUMMARY OF THE INVENTION

Hence, it is the object of the present invention to realize a tensioning rail unit of the above-mentioned type at a reasonable price and such that it is reliable in operation.

In the case of a tensioning rail unit of the above-mentioned type, this object is achieved in that the first or the second element is configured as an accommodation pocket open in the direction of the pivot axis, said accommodation pocket being provided with an pocket opening having a lateral opening which is open over an angular range of less than 180°, and the respective other element is configured as a pivot pin held by means of a fastening section, the fastening section being dimensioned such that, at the mounting position, it can be attached in the direction of the pivot axis due to the lateral opening of the accommodation pocket and engages then, by means of the subsequent pivoting movement, a locking slot intersecting the pocket opening, said locking slot being formed in the accommodation pocket.

This embodiment is advantageous insofar as the plug-in movement and the subsequent pivoting movement (bayonet catch) can take place along and about the pivot axis and are therefore very easy to automate. Therefore, the whole mounting operation can be carried out such that it is guided by means of the pivot pin. In addition, the use of a clip connection can be dispensed with, and the pivotable arrangement can thus be provided with a more stable structural design. In particular, the angular range of the lateral opening can be chosen such that the pivot pin will be retained in the accommodation pocket in a stable manner. The closed circumferential area of the accommodation pocket can thus be configured stably enough for not releasing the pivot pin due to elastic deformation, as must be the case with a clip connection. Hence, the accommodation pocket can also very easily take up the forces at the transport position.

According to a preferred embodiment, the pivot pin may be arranged on the arm of the housing and the accommodation pocket may be arranged on the tensioning rail. Normally, metal die casting materials are used for the tensioner housings. This guarantees an adequately stable arrangement of the pivot pin. The design of the accommodation pocket is only subjected to a small number of restrictions in the case of a tensioning rail, since tensioning rails of tensioning rail units are normally produced from plastic material by means of injection molding.

According to an advantageous embodiment, the lateral opening may be open over an angular range of less than 120°, whereby a stable accommodation pocket surrounding the pivot pin over at least 240° is formed.

In order to provide a sufficiently large area of overlap between the arm of the housing and the tensioning rail, in which area said arm engages the locking slot, an embodiment is configured such that the bottom of the locking slot extends in an angular range of ±20° relative to a contacting line between the pivot axis and a point of contact between the tensioning rail and the tensioning piston at a transport position of the tensioning rail unit. At the transport position, a defined position between the tensioning rail and the tensioner is given, since these two elements are locked against each other in a condition of preload. Starting from this imaginary contacting line, the bottom of the locking slot has a certain profile. If the locking slot does not have a straight or flat bottom, it will also be possible to apply, starting from the pivot axis, a tangent to the bottom so as to determine the angle.

In order to achieve safe locking through sufficient pivoting of the tensioning rail, a variant may be configured such that the center line of the lateral opening intersecting the pivot axis may extend in an angular range of 70° to 100° relative to a contacting line between the pivot axis and a point of contact between the tensioning rail and the tensioning piston at a transport position of the tensioning rail unit. This guarantees that the tensioning rail must be pivoted relative to the pivot pin to a certain minimum extent between the mounting position and the transport position. This minimum extent is at least 70° in the case of the here described variant.

In order to guarantee that the pivot pin is sufficiently guided in the accommodation pocket, the pocket opening may extend over a section corresponding to at least 50% of the overall height of the accommodation pocket. This provides sufficient space for the fastening section and the arm can be brought into alignment with the locking slot. The pivot pin can thus be introduced sufficiently deep into the accommodation pocket.

It is, however, also possible to configure the accommodation pocket such that it is closed in the direction of the pivot axis on one side thereof. This provides a stop for the pivot pin on one side, said stop representing an additional orientation aid during the mounting operation.

Moreover, it is possible that, in the direction of the pivot axis, the pivot pin projects beyond the fastening section on both sides of the latter, and that the accommodation pocket includes an accommodation hole having a closed circumference and receiving therein one projecting side of the pivot pin. Hence, 360° guidance for the pivot pin is provided at least on one side. On the one hand, this serves to execute the mounting operation, in particular the pivoting movement taking place until the arm enters the locking slot, and, on the other hand, the pivot pin is, at the operating position, guided in the accommodation pocket on both sides of the fastening section, thus allowing the pivoting movement to be guided in a dimensionally very accurate manner.

In order to be able to influence the available pivoting movement between the tensioner and the tensioning rail, the longitudinal center line of the arm of the housing may intersect the longitudinal center line of the pivot pin off center.

In particular the embodiment according to which, at least in the area of the accommodation pocket, a side of the arm of the housing facing the back of the tensioning rail intersects the pivot pin with a lesser extent of displacement relative to the pivot axis than a side of the arm of the housing facing away from the back of the tensioning rail, offers the possibility of producing a variant having a flat structural design, since the arm of the housing need not be pivoted into the locking slot of the tensioning rail as deeply as would be necessary if the pivot pin were arranged e.g. symmetrically at the end of the arm.

According to a preferred embodiment, a transport lock used for locking the tensioner and the tensioning rail at the transport position may be provided on the arm of the housing and at the associated location of the tensioning rail. This locking normally takes place under preload. This preload is applied by means of a spring provided normally in the interior of the tensioner. Said spring tries to push the tensioning rail away from the housing of the tensioner. According to a preferred variant, a locking pin is provided, which is adapted to be inserted into registrable openings on the tensioning rail and on the housing of the tensioner.

Preferably, the housing, the arm and the pivot pin of the tensioner may be formed integrally with one another. The material used for the housing of a tensioner is often a metallic material. In this case, production by means of a metal die casting process is one of the obvious possibilities to use.

According to a variant, also the tensioning rail and the accommodation pocket may be formed integrally with one another. Tensioning rails, in particular those belonging to tensioning rail units, are normally produced from a plastic material in one part. Hence, it is possible to form, by means of an injection molding process, the accommodation pocket on the tensioning rail such that it is integral therewith.

### BRIEF DESCRIPTION OF THE DRAWINGS

In the following, the present invention will now be explained in more detail making reference to an embodiment.

FIG. 1 shows a first embodiment of the tensioning rail unit according to the present invention in a perspective view,

FIG. 2 shows a top view of the tensioning rail unit according to FIG. 1,

FIG. 3 shows a front view of the tensioning rail unit according to FIG. 1, part of said front view being a sectional view,

FIG. 4 shows a rear of view of the tensioning rail unit according to FIG. 1, part of said rear view being a sectional view,

FIG. 5 shows a perspective view of first mounting step for fitting together the tensioning rail unit according to FIG. 1,

FIG. 6 shows a perspective view of a second mounting step for fitting together the tensioning rail unit according to FIG. 1,

FIG. 7 shows a perspective view of a third mounting step for fitting together the tensioning rail unit according to FIG. 1.

### DETAILED DESCRIPTION

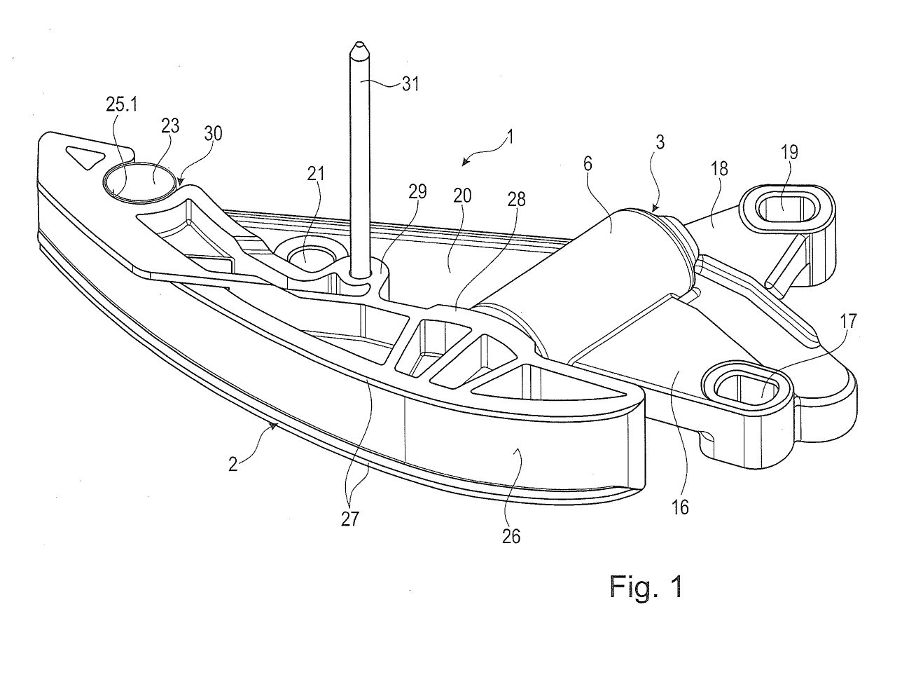

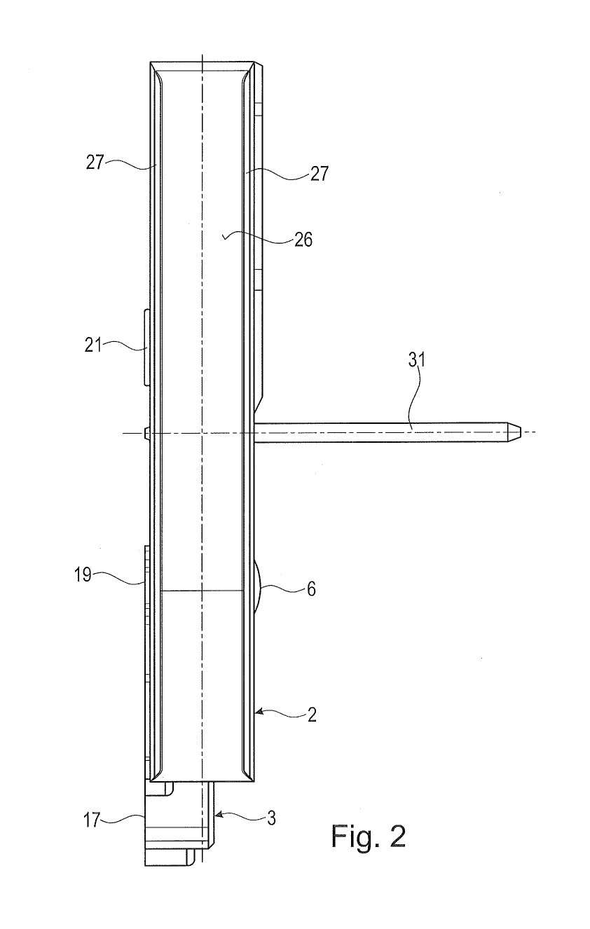

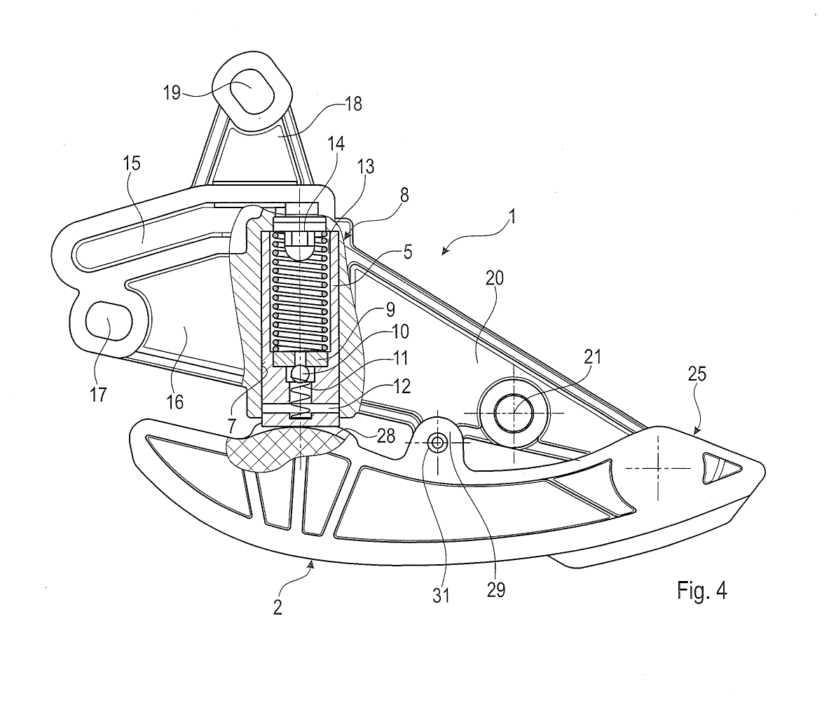

The tensioning rail unit 1 shown in FIGS. 1 to 5 is used in a chain drive of an internal combustion engine (not shown). One possibility of use is e.g. the oil pump drive. The tensioning rail unit 1 comprises a pivotably arranged tensioning rail 2 and a tensioner 3 coupled thereto. The tensioning rail 2 consists of plastic material and is produced by means of injection molding. The tensioner 3 comprises a housing 4 produced by means of a metal die casting process and a tensioning piston 5 displaceably guided in said housing 4 (cf. FIG. 4). To this end, the housing 4 comprises a cylindrical housing section 6 provided with a piston bore 7 in which the tensioning piston 5 is guided. The tensioning piston 5 is configured as a hollow piston and comprises in the interior thereof a compression spring 8 resting on the bottom of the piston bore 7, a vent valve disk 9 and a vent valve body 10 preloaded by means of a valve spring 11. The valve spring 11 is guided in a bore, which, in turn, is in flow communication with a transversely extending vent hole 12. The tensioning piston 5 and the bottom of the piston bore 7 have formed between them a pressure chamber 13 that is adapted to be filled with hydraulic fluid by means of a check valve 14 arranged in the bottom of the piston bore 7. The housing 4 has additionally provided therein a feed channel 15, which is connectable to the engine oil hydraulic system of the internal combustion engine and which supplies the pressure chamber 13 with hydraulic fluid. The vent valve body 10 is simultaneously used as a pressure-relief valve and has therefore also a certain influence on the damping behavior. Normal damping is, however, produced by means of a leakage gap between the tensioning piston 5 and the piston bore 7.

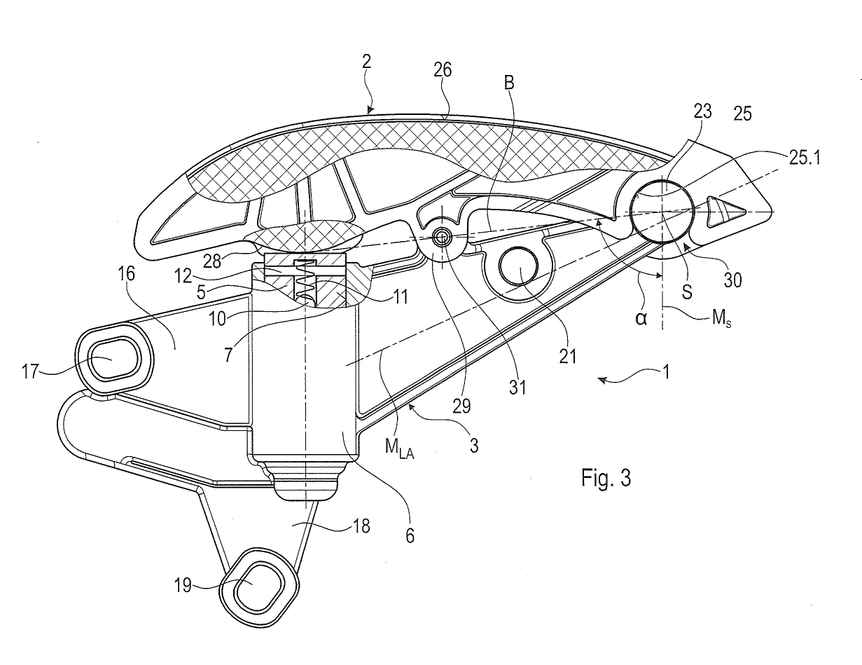

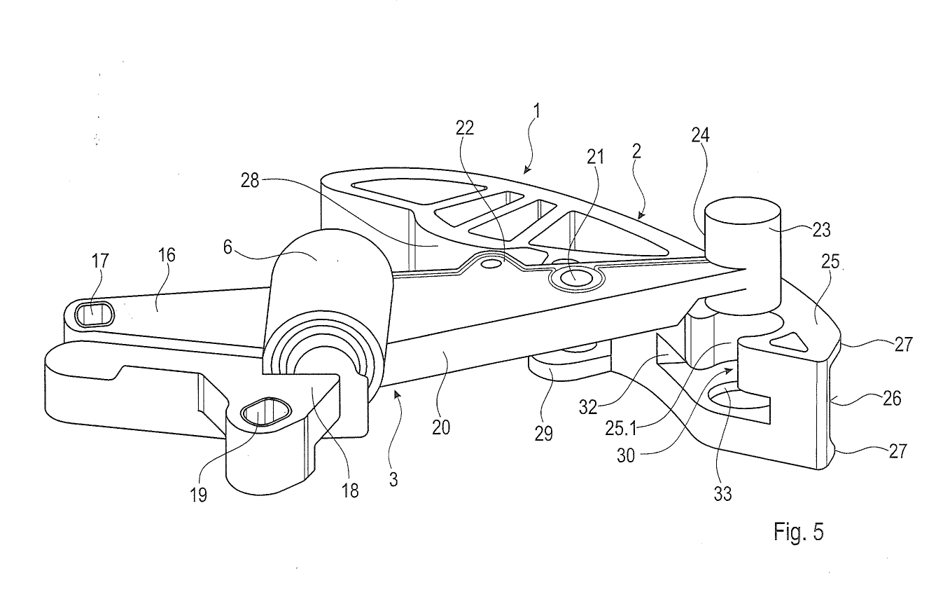

The housing 4 has a shorter fastening arm 16 along which the housing component defining the feed channel 15 extends. At the end of the short arm 16, a fastening eye 17 is provided. A second short arm 18 comprising a second fastening eye 19 is positioned approximately in extension of the cylindrical housing section 6. A long arm 20 is positioned on the housing section 6 in opposed relationship with the first short arm 16, said long arm 20 becoming narrower towards its free end so that, when seen in a front view, it is substantially triangular in shape. The long arm 20 has formed therein a fastening eye 21 in its central area. A locking eye 22 used for locking the tensioner 3 and the tensioning rail 2 is arranged in a protruding mode of arrangement on the long arm 20 beside the fastening eye 21 and displaced towards the housing section 6. The free end of the long arm 20 has provided thereon a cylindrical pivot pin 23. Said pivot pin 23 is attached to the free end of the long arm 20 by means of a fastening section 24, which is slightly thinner than the rest of the long arm 20 (cf. FIG. 5). Hence, the pivot pin 23 projects beyond the fastening section 24 on both sides thereof. The projecting lengths are, however, not symmetrical, but the pivot pin 23 projects to a greater extent towards the front of the tensioning rail unit 1 (cf. FIG. 3) than towards the rear of the tensioning rail unit 1 (cf. FIG. 4). The long arm 20 has a center line M_{LA} corresponding substantially to the angle bisector of the angle enclosed by the upper and lower surfaces of the long arm 20 (cf. FIG. 3). This center line M_{LA} intersects the pivot pin 23 asymmetrically, i.e. the pivot axis S is displaced relative to the center line M_{LA} (in FIG. 3 the pivot axis S extends above the center line M_{LA}). The pivot axis S is oriented perpendicularly to the longitudinal axis of the tensioning piston 5.

At its end connected to the pivot pin 23, the tensioning rail 2 has an accommodation pocket 25, which will be described in more detail hereinbelow. The front of the tensioning rail 2 is provided with a curved (convex) sliding surface 26, which is laterally delimited by guide ridges 27. During operation, the chain slides along this sliding surface 26. On the back of the tensioning rail 2, which faces the tensioner 3, there are, on the one hand, a convex press-on section 28, onto which the end face of the tensioning piston 5 presses, and, on the other hand, two spaced-apart, projecting locking eyes 29, which laterally overlap the locking eye 22 on the housing 4 and which can be brought into alignment therewith. A stabilizing truss structure is provided between the sliding surface 26 and the lower surface of the tensioning rail 2.

When seen in the direction of the pivot axis S, the accommodation pocket 25 is open towards the upper surface of the tensioning rail unit 1 and defines a pocket opening 25.1. The upper section of the pocket opening 25.1 has a lateral opening 30. The lateral opening 30 extends over an angular range of approx. 60° (smaller than 120°) of the pocket opening 25.1, so that the pocket opening 25.1 is closed over approx. 300° of its circumference. The pocket opening 25.1 has a cylindrical inner surface accommodating therein the pivot pin 23 in a substantially accurately fitting but nevertheless pivotable manner. The orientation of the lateral opening 30 is such that the center line M_{S} of the lateral opening 30 is oriented at an angle α relative to an imaginary contacting line B, said angle α corresponding substantially to an angle of approx. 80° (between 70° and) 100°. The imaginary contacting line B (cf. FIG. 3) intersects the pivot axis S and the point of contact between the end face of the tensioning piston 5 and the press-on section 28, this being a view based on the transport position shown in FIG. 3. As can be seen from FIG. 3, the contacting line B also intersects the center axes of the locking eyes 22 and 29 at a position of alignment. At the transport position, the tensioning rail 2 and the tensioner 3 are locked relative to each other by means of a locking pin 31 passed through the locking eyes 22 and 29. This is done against the preload of the compression spring 8. Approximately in the middle of the height of the tensioning rail 2, the pocket opening 25.1 and the lateral opening 30 are intersected by a locking slot 32 (cf. FIG. 5). The width of the locking slot 32 is slightly larger than the thickness of the fastening section 24, so that the latter can extend into the locking slot 32. In the lower, closed side of the accommodation pocket 25, i.e. in one side of the locking slot 32, an accommodation hole 33 (cf. FIG. 5) is provided, said accommodation hole 33 being formed in extension of the pocket opening 25.1 and in alignment therewith. The accommodation hole 33 is closed on its circumference and it is also closed at the bottom. The diameter of the accommodation hole 33 corresponds substantially to the diameter of the pocket opening 25.1, so that the lesser projecting part of the pivot pin 23 can be accommodated in this accommodation hole 33. The length of the pivot pin 23 is adapted to the structural design of the accommodation pocket 25, so that the pivot pin 23, once inserted in the accommodation pocket 25, will not project in the direction of the pivot axis S. The pocket opening 25.1 has a height corresponding to approx. 70% (at least 50%) of the height of the accommodation pocket 25, the height of the accommodation hole 33 being not added to the height of the pocket opening 25.1.

The width of the fastening section 24 is adapted to the width of the lateral opening 30, so that, when suitably oriented, the pivot pin 23 and the long arm 20 arranged thereon can be introduced into the accommodation pocket 25 in the direction of the pivot axis S.

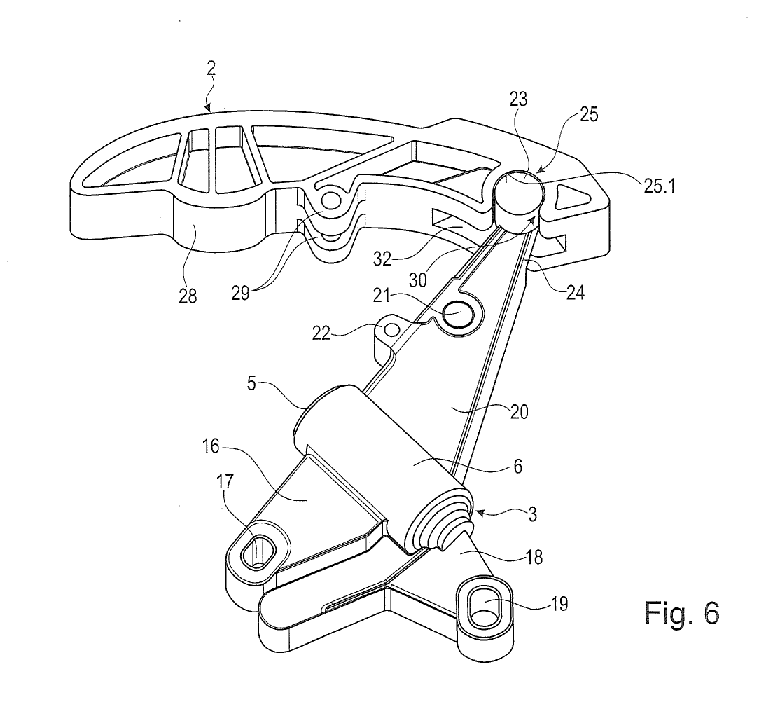

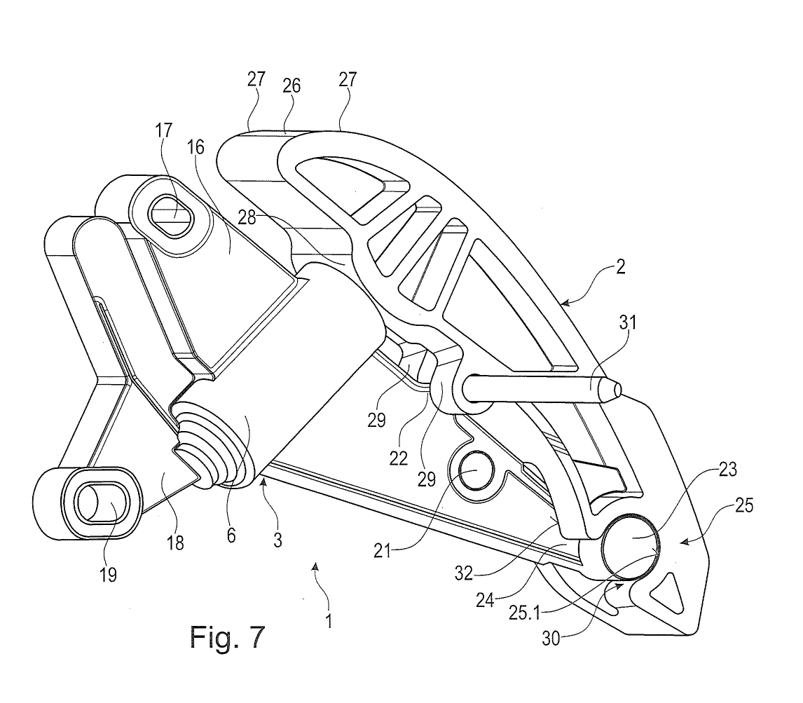

Making reference to FIGS. 5 to 7, the mounting operation between the tensioning rail 2 and the tensioner 3 will be explained hereinbelow in more detail. As can be seen in FIG. 5, the tensioner 3 and the tensioning rail 2 are oriented relative to one another such that the pivot axis S extends through the axis of the pivot pin 23 as well as through the axis of the pocket opening 25.1. In addition, the long arm 20 is oriented by pivoting the tensioning rail 2 and the tensioner 3 relative to one another, so that the fastening section 24 is oriented at a position above the lateral opening 30 such that it can be introduced into the lateral opening 30. By moving the tensioning rail 2 and the tensioner 3 relative to one another along the pivot axis S, the pivot pin 23 is, together with the fastening section 24, introduced in the accommodation pocket 25 (cf. FIG. 6). The fastening section 24 is thus brought into alignment with the locking slot 32 due to the structural design of the accommodation hole 33 and of the locking slot 32. Subsequently, the tensioning rail 2 and the tensioner 3 can be moved towards one another by pivoting these two elements relative to one another, with the lower part of the pivot pin 23 being guided in the accommodation hole 33. This has the effect that the fastening section 24 pivots into the locking slot 32, whereby the tensioning rail 2 and the tensioner 3 are locked over a predetermined angular range in the direction of the pivot axis S. Pivoting is continued until the tensioning piston 5 comes into contact with the press-on section 28. Subsequently, a force is applied to the tensioning rail 2, thus pivoting the latter still further towards the tensioner 3, so that the compression spring 8 is compressed, until the locking eye 22 is in alignment with the locking eyes 29. At this position, the locking pin 31 is introduced so as to secure the then existing transport position (cf. FIG. 7).

At this preloaded transport position, the tensioning rail unit 1 can then be transferred to the internal combustion engine and secured in position by means of the fastening eyes 17, 19 and 21 and by using suitable bolts. As soon as all the mounting steps have been finished, the tensioning rail unit 1 can be unlocked by removing the locking pin 31. Then, the sliding surface 26 of the tensioning rail 2 will come into contact with the chain to be tensioned. The tensioning rail unit 1 is now at an operating position. The operating position is located between the transport position shown in FIG. 7 and the mounting position shown in FIG. 6, so that locking of the pivot pin 23 in the accommodation pocket 25 by means of an overlap between the fastening section 24 and the locking slot 32 is guaranteed. On the basis of this structural design, the accommodation pocket 25 can be configured so stable that it will reliably withstand also the forces acting thereon at the transport position. This is guaranteed especially by the fact that the pocket opening 25.1 surrounds the pivot pin 23 around a large circumferential area thereof. In addition, the pivot pin 23 is also secured in position in the accommodation hole 33 around its entire circumference.

The structural design of the pivot connection between the tensioning rail 2 and the tensioner 3 allows not only a stable design thereof, but, due to the geometric boundary conditions, the associated mounting can also be automated more easily than in the case of hitherto known structural designs of such pivot connections. In addition, a big advantage is to be seen in that the tensioning rail 2 is configured as an integral or one-piece component, i.e. together with the accommodation pocket 25, and that also the pivot pin 23 is an integral component part of the housing 4 of the tensioner 3. When the tensioning rail unit 1 is mounted to an internal combustion engine, a connection between the feed channel 15 and a feed opening of the engine oil hydraulic system is simultaneously established.

1. A tensioning rail unit for an endless drive, comprising a tensioning rail arranged for pivoting about a pivotable arrangement and a tensioner acting on the tensioning rai and including a housing and a tensioning piston guided in said housing, wherein the housing has an arm having attached thereto a first element of the pivotable arrangement, the tensioning rail has attached thereto a second element of the pivotable arrangement, and the first and second elements are adapted to be mounted at a mounting position by means of a plug-in movement and to be transferred to a locked operating position by means of a subsequent pivoting movement, wherein the first or the second element is configured as an accommodation pocket open in the direction of the pivot axis, said accommodation pocket being provided with a pocket opening having a lateral opening which is open over an angular range of less than 180°, and that the respective other element is configured as a pivot pin held by means of a fastening section, the fastening section being dimensioned such that, at the mounting position, it can be attached in the direction of the pivot axis due to the lateral opening of the accommodation pocket and can be brought into engagement with a locking slot, which intersects the pocket opening, by means of the subsequent pivoting movement.

2. The tensioning rail unit according to claim 1, wherein the pivot pin is arranged on the arm of the housing and the accommodation pocket is arranged on the tensioning rail.

3. The tensioning rail unit according to claim 1, wherein the lateral opening is open over an angular range of less than 120°.

4. The tensioning rail unit according to claim 1, wherein the bottom of the locking slot extends in an angular range of ±20° relative to a contacting line between the pivot axis and a point of contact between the tensioning rail and the tensioning piston at a transport position of the tensioning rail unit.

5. The tensioning rail unit according to claim 1, wherein a center line of the lateral opening intersecting the pivot axis extends in an angular range of 70° to 100° relative to a contacting line between the pivot axis and a point of contact between the tensioning rail and the tensioning piston at a transport position of the tensioning rail unit.

6. The tensioning rail unit according to claim 1, wherein the pocket opening of the accommodation pocket extends over a section corresponding to at least 50% of the overall height of the accommodation pocket.

7. The tensioning rail unit according to claim 1, wherein the accommodation pocket is configured such that it is closed in the direction of the pivot axis on one side thereof.

8. The tensioning rail unit according to claim 1, wherein, in the direction of the pivot axis, the pivot pin projects beyond the fastening section on both sides of the latter, and that the accommodation pocket includes an accommodation hole having a closed circumference and receiving therein one projecting side of the pivot pin.

9. The tensioning rail unit according to claim 1, wherein the longitudinal center line of the arm of the housing intersects the longitudinal center line of the pivot pin off center.

10. The tensioning rail unit according to claim 1, wherein, at least in the area of the accommodation pocket, the side of the arm of the housing facing the back of the tensioning rail intersects the pivot pin with a lesser extent of displacement relative to the pivot axis than the side of the arm of the housing facing away from the back of the tensioning rail.

11. The tensioning rail unit according to claim 1, wherein a transport lock used for locking the tensioner and the tensioning rail at the transport position is provided on the arm of the housing and at an associated location of the tensioning rail.

12. The tensioning rail unit according to claim 1, wherein the housing, the arm and the pivot pin of the tensioner are formed integrally with one another.

13. The tensioning rail unit according to claim 1, wherein the tensioning rail, and the accommodation pocket are formed integrally with one another.
